(19) United States
(12) Patent Application Publication
(10) Pub. No.: US 2024/0329812 A1
(43) Pub. Date: Oct. 3, 2024

(54) METHOD, APPARATUS, DEVICE AND STORAGE MEDIUM FOR PAGE PROCESSING

(71) Applicant: Beijing Zitiao Network Technology Co., Ltd., Beijing (CN)

(72) Inventors: Qi XU, Beijing (CN); Xiaoyun HU, Beijing (CN); Qin YU, Beijing (CN); Hui SUN, Beijing (CN)

(21) Appl. No.: 18/574,423

(22) PCT Filed: Oct. 19, 2022
(86) PCT No.: PCT/CN2022/126066

§ 371 Date: Dec. 27, 2023

(30) Foreign Application Priority Data
Oct. 19, 2021 (CN) 202111215089.X

(51) Int. Cl. G06F 3/0484

(52) U.S. Cl. CPC G06F 3/0484

(57) ABSTRACT

Embodiments of the present disclosure disclose a method, an apparatus, a device and a storage medium for interface processing. The method comprises: displaying, in a predetermined application on a first user side, an associated interface of a first user, where the associated interface comprises an object identifier corresponding to at least one object created by the first user and configured to create a media content; and in response to triggering on a target object identifier, displaying an attribute setting interface of a target object corresponding to the target object identifier.

### CROSS-REFERENCE TO RELATED APPLICATION

This application claims priority to Chinese Patent Application No. 202111215089.X, filed on Oct. 19, 2021, which is incorporated herein by reference in its entirety.

### FIELD

Embodiments of the present disclosure relate to the field of computer technologies, and for example, relate to a method, an apparatus, a device and a storage medium for interface processing.

### BACKGROUND

With the continuous development of Internet technologies, an application (APP) can show various media contents to users, and different users can share their works with each other in the form of posting videos and other media contents.

### SUMMARY

The embodiments of the present disclosure provide a method, an apparatus, a storage medium and a device for interface processing, which can optimize interface processing solutions in the related art.

In a first aspect, an embodiment of the present disclosure provides a interface processing method, on a first user side, including:
displaying an associated interface of a first user in a predetermined application, where the associated interface includes an object identifier corresponding to at least one object, the first user is an author of the at least one object, and the at least one object is configured to create a media content; and
displaying, in response to triggering for a target object identifier, an attribute setting interface of a target object corresponding to the target object identifier, where the target object is one of the at least one object, and the target object identifier is an object identifier corresponding to the target object.

In a second aspect, an embodiment of the present disclosure provides a interface processing method, on a second user side, including:
displaying, in an associated interface of a first user in a predetermined application, an object identifier of the at least one object according to an attribute setting result by the first user for the at least one object, where the second user is different from the first user, the first user is an author of the at least one object, the at least one object is configured to create a media content, and the first user enters a corresponding attribute setting interface by triggering an object identifier in the associated interface of the first user in the predetermined application.

In a third aspect, an embodiment of the present disclosure provides a interface processing apparatus, configured on a first user side and including:
an associated interface displaying module, configured to display an associated interface of a first user in a predetermined application, where the associated interface includes an object identifier corresponding to at least one object, the first user is an author of the at least one object, and the at least one object is configured to create a media content; and
an attribute setting module, configured to display, in response to triggering for a target object identifier, an attribute setting interface of a target object corresponding to the target object identifier, where the target object is one of the at least one object, and the target object identifier is an object identifier corresponding to the target object.

In a fourth aspect, an embodiment of the present disclosure provides a interface processing apparatus, configured on a second user side and including:
an object identifier displaying module, configured to display, in an associated interface of a first user in a predetermined application, an object identifier of the at least one object according to an attribute setting result by the first user for the at least one object, where the second user is different from the first user, the first user is an author of the at least one object, the at least one object is configured to create a media content, and the first user enters a corresponding attribute setting interface by triggering an object identifier in the associated interface of the first user in the predetermined application.

In a fifth aspect, an embodiment of the present disclosure provides an electronic device, including a memory, a processor and a computer program stored on the memory and runnable on the processor, where the processor, when executing the computer program, implements the interface processing method as provided by the embodiments of the present disclosure.

In a sixth aspect, an embodiment of the present disclosure provides a computer-readable storage medium, on which a computer program is stored, where the computer program, when executed by a processor, implements the interface processing method as provided by the embodiments of the present disclosure.

### BRIEF DESCRIPTION OF THE SEVERAL VIEWS OF THE DRAWINGS

FIG. 1 is a schematic flowchart of a interface processing method according to an embodiment of the present disclosure;

FIG. 2 is a schematic flowchart of another interface processing method according to an embodiment of the present disclosure:

FIG. 3 is a schematic diagram of interface interaction according to an embodiment of the present disclosure;

FIG. 4 is a schematic flowchart of yet another interface processing method according to an embodiment of the present disclosure;

FIG. 5 is a schematic diagram of interface comparison according to an embodiment of the present disclosure;

FIG. 6 is a structural block diagram of a interface processing apparatus according to an embodiment of the present disclosure;

FIG. 7 is a structural block diagram of another interface processing apparatus according to an embodiment of the present disclosure; and

FIG. 8 is a structural block diagram of an electronic device according to an embodiment of the present disclosure.

### DETAILED DESCRIPTION

It should be understood that the steps described in the method embodiments of the present disclosure may be performed in a different order and/or in parallel. Furthermore, the method embodiments may include additional steps and/or omit performing the illustrated steps. The scope of the present disclosure is not limited in this regard.

As used herein, the term “include” and its variants should be construed as open terms meaning “including, but not limited to”. The term “based on” means “at least partially based on”. The term “one embodiment” means “at least one embodiment”. The term “another embodiment” means “at least one another embodiment”. The terms “some embodiments” means “at least some embodiments”. Related definitions of other terms will be given in the following descriptions.

It should be noted that the concepts of “first”, “second” and the like mentioned in the present disclosure are used only to distinguish different apparatuses, modules or units but not to limit the order or interdependence of the functions performed by these apparatuses, modules or units.

It should be noted that the modifications of “a” and “a plurality” mentioned in the present disclosure are schematic rather than limiting, and it should be understood by those skilled in the art that unless otherwise explicitly stated in the context, they should be understood as “at least one”.

Names of messages or information interacted among multiple apparatuses in the embodiments of the present disclosure are used for illustrative purposes only but are not intended to limit the scope of these messages or information.

In the following embodiments, both optional features and examples are provided in each embodiment, the individual features described in the embodiments may be combined to form a plurality of optional solutions, and each numbered embodiment should not be considered as only one technical solution.

In order to improve the quality of the released media content and attract more users to view them, the users may carry out some processing when creating the media content. The processing may be complicated, and if all of the processing is completed manually by the users, more energy may be required, and as a result the difficulty in releasing the media content may be increased. At present, an application can provide the users with objects such as props or templates for creating the media content, and the media content may be produced conveniently by using the above objects. Some application platforms can support the users in creating the objects via an authoring tool side and release the objects on a server corresponding to the application. However, at present, the object authors need to enter the authoring tool side in order to manage props or templates produced by themselves, but cannot conveniently manage the objects produced by themselves on the application side.

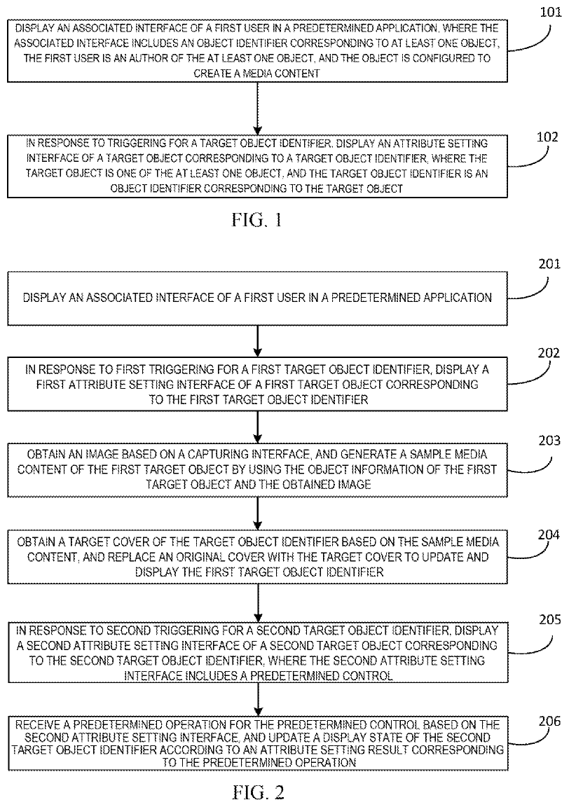

FIG. 1 is a schematic flowchart of a interface processing method according to an embodiment of the present disclosure. The method may be executed by a interface processing apparatus, and the apparatus may be implemented by software and/or hardware, and generally may be integrated into an electronic device. The electronic device may be understood as a first user side, i.e., an electronic device used by a first user. As shown in FIG. 1, the method includes the following steps.

In step 101, an associated interface of a first user is displayed in a predetermined application, where the associated interface includes an object identifier corresponding to at least one object, the first user is an author of the at least one object, and the object is configured to create a media content.

In the embodiments of the present disclosure, the predetermined application may be installed in an electronic device. The electronic device may be mobile devices or portable devices such as a mobile phone, a smart watch, a tablet computer and a personal digital assistant, and may also be other types of devices, which is not limited herein. The predetermined application may provide a function of creating the media content and may also provide the object for creating the media content. The user may register an account in the predetermined application and log in to the account. The media content may include pictures, audio or video, and is generally presented in the form of works, such as posters, songs or video.

For example, the user may upload the works to be released to a server corresponding to the predetermined application, and the works may be distributed to predetermined applications used by other users for display. Taking a specific application scenario as an example, the predetermined application includes a video application, and the media content includes video. The author of the video may create the video by using the video application, and upload the created video works to a video platform. The video platform may distribute the video works to other video applications used by other users for playback, so that other users may view the video works released by the author of the video in the video applications.

Generally, in order to improve the quality of the released media content and attract more users to view them, the user may perform some processing when creating the media content. However, the processing may be complicated, such as adding special effects to the video or clipping video materials, and if all the processing is completed manually by the users, more energy may be required, and as a result the difficulty in releasing the media content may be increased. Therefore, the predetermined application may provide the users with objects such as props or templates for creating the media content, and the media content may be produced conveniently by using the above objects. In order to enrich the objects in a platform, the users can be supported in creating the objects via an authoring tool side and releasing the objects on a server side corresponding to the predetermined application. The authoring tool side is generally a computer device with high computing capability or high configuration, such as a notebook computer, a desktop computer, a server or other professional devices.

In the embodiments of the present disclosure, the first user may be understood as any user who creates an object (authoring tool such as a prop or a template), or called an object author, or there may be different naming methods according to different types of objects. In the embodiments of the present disclosure, the object may include a prop or a template or the like, and the first user may also be called a prop master or a template master or the like. For different types of media contents, the objects may have different functions. When the media content is a picture, the object may have the functions of facial beautifying treatment, adding special effects, adding filters, making posters or the like; when the media content is audio, the object may have the functions of voice extraction, voice change processing, adding background sound effects, filtering noise or the like; and when the media content is video, the object may have the functions of facial beautifying treatment, adding animation special effects, adding filters, adding dynamic stickers, clipping video materials or the like.

In the embodiments of the present disclosure, the associated interface may be understood as a interface for displaying the object, the associated interface of the first user may be understood as a interface for displaying the object created by the first user, and an object identifier corresponding to the object may be displayed in the interface. The display form of the object identifier is not limited, and for example, may include at least one combination of characters, icons, static images, dynamic images and video. The associated interface may include an object details interface for displaying a single object, or an object list interface for displaying a plurality of objects. For example, after the first user creates a certain object (recorded as a first object) by means of the authoring tool side, the first object may be uploaded to a server side corresponding to the predetermined application by means of the authoring tool side, and the server side may process the first object and then release the processed first object in public, so that the first user may view a first object identifier corresponding to the first object in the associated interface of the first user in the predetermined application on the first user side. In addition, a second user (any user other than the first user) may also view the first object identifier corresponding to the first object in the associated interface of the first user in the predetermined application on a second user side.

For example, the associated interface may display object identifiers corresponding to a plurality of objects one by one, or display the object identifiers corresponding to some or all of the objects in batches, and the display mode may be flexibly determined according to an actual interface layout and the number of objects created by the first user. In the associated interface, the display of different object identifiers may be switched by swiping and other operations.

In step 102, an attribute setting interface of a target object corresponding to a target object identifier is displayed in response to triggering for a target object identifier, where the target object is one of the at least one object, and the target object identifier is an object identifier corresponding to the target object.

In the related art, the object author can only manage the object created by himself/herself on the authoring tool side, which is not convenient enough, is lacking in management function and deep in operation path, and hence is not conducive to discovery and use of the management function by the object author. As a result, after the object is released and becomes available to other users, the object author can no longer manage the object.

In the embodiments of the present disclosure, the attribute setting interface of the object is added in the predetermined application, which is convenient for the first user to perform management operations such as attribute setting on the object created by the first user himself/herself via the attribute setting interface.

In the related art, on the first user side, the object identifier in the associated interface of the first user usually cannot be triggered, or after being triggered, only displaying detailed information corresponding to the object or displaying a details interface containing the detailed information can be performed. The detailed information may include, for example, release time of the object or the media contents created by other users using the object, and the first user cannot perform more operations on the object. However, in the embodiments of the present disclosure, the first user is supported in triggering a certain object identifier, and the triggering for the target object identifier input by the first user may be received. The target object identifier is an identifier corresponding to the target object, and the target object may be understood as an object on which the first user currently wants to perform attribute setting. The triggering is not limited in operation type, and for example may be clicking, long press or swiping; and the triggering is not limited in action position, and for example may be in any position or a predetermined triggering position of the target object identifier. Triggering type and/or a predetermined triggering position may be associated with the attribute setting interface. For example, when there are a plurality of attribute setting interfaces, different attribute setting interfaces may correspond to different triggering types and/or predetermined triggering positions.

For example, after the triggering for the target object identifier input by the first user is received, the attribute setting interface of the target object corresponding to the target object identifier is displayed in response to the triggering. The attribute setting interface may provide a function of setting a predetermined attribute of the target object. A corresponding attribute setting result may be obtained by receiving, based on the attribute setting interface, an operation of setting the predetermined attribute of the target object input by the first user, and the target object and/or the target object identifier may be updated correspondingly based on the attribute setting result. The predetermined attribute is not limited in type, and may be set according to actual needs, such as whether to delete the target object or the target object identifier, the visibility of the target object identifier, the display mode of the target object identifier and the display position of the target object identifier.

For example, after the corresponding attribute setting result is obtained by receiving, based on the attribute setting interface, the operation of setting the predetermined attribute of the target object input by the first user, data corresponding to the attribute setting result may be transmitted to the server side, so that other users may update, after refreshing and displaying the associated interface of the first user again, a presented object in a way that matches the attribute setting result.

According to the interface processing method provided in the embodiments of the present disclosure, the associated interface of the first user is displayed in the predetermined application on the first user side, the associated interface includes the object identifier corresponding to the at least one object created by the first user and configured to create the media content, and the attribute setting interface of the target object corresponding to the target object identifier is displayed in response to the triggering for the target object identifier. By adopting the technical solution described above, the author of the object for creating the media content may display the attribute setting interface of the object by triggering the object identifier in the associated interface for displaying the object identifier, so that the object author can perform attribute setting on the object created by himself/herself in the application without having to do so on a professional authoring tool side, which improves the convenience of object management.

In some embodiments, displaying, in response to the triggering for the target object identifier, the attribute setting interface of the target object corresponding to the target object identifier includes: displaying, in response to first triggering for the target object identifier, a first attribute setting interface of the target object corresponding to the target object identifier, where the first attribute setting interface includes a capturing interface, and the capturing interface is associated with object information of the target object. Such setting has the advantage that image information can be obtained by means of capturing, and then attribute setting may be performed on the target object according to the image information.

For example, the object information may include the content in an object to which the object information belongs, i.e., the object information of the target object may include the content in the target object. The content in the object may include related materials (including image materials such as stickers and pendants, and sound materials such as background music), related algorithms (including image processing algorithms such as facial beautifying or image recognition, and audio processing algorithms such as voice extraction) and other related contents (for example, related parameter values) involved when the object is configured to create the media content. The content in the object may be determined according to the type of the object. For example, when the object is a prop, the content in the object may be determined based on the fact that the object is a prop. The capturing interface is associated with the object information of the target object, for example, by the way of loading and displaying the related materials described above, using the related algorithms described above or setting the related parameter values. Alternatively, when the target object is configured to create the media content, if it is necessary to display the capturing interface, the expression form of the capturing interface may be the same as that of the capturing interface included in the first attribute setting interface.

In some embodiments, after displaying the capturing interface, the method further includes: obtaining an image based on the capturing interface, and generating a sample media content of the target object by using the object information of the target object and the image; and displaying the sample media content in association with the target object. Such setting has the advantages that the object author can be allowed to capture the sample media content that makes use of the object created by the object author himself/herself, and to display the sample media content in association with the object, which can enrich the display form of the object and enable the object author to more intuitively convey the use method and the creative idea of his/her works to other users, thereby helping other users understand the object quickly and accurately and improving the use efficiency of the object.

For example, a capturing screen includes the target object after the capturing interface is displayed, the first user may trigger a capturing button, and further, the sample media content of the target object is generated according to the object information of the target object and a shot image.

For example, the sample media content is displayed in association with the target object, for example, the sample media content may be displayed in association with the target object identifier, and the associated display may be performed in the associated interface of the first user. The way of associated display is not limited, i.e., all or part of the sample media content may be displayed within an associated range of the target object identifier (for example, an area on the right side of the target object identifier whose distance from the target object identifier is less than a predetermined distance threshold); and all or part of the sample media content may also be displayed within the target object identifier.

In some embodiments, displaying the sample media content in association with the target object includes: obtaining a target cover of the target object identifier based on the sample media content; and updating and displaying the target object identifier based on the target cover, where the target object identifier includes the target cover. Such setting has the advantages that compared with identifiers such as icons and text descriptions in the related art, adding a cover to the object identifier can enrich the display mode of the object identifier, improve the attraction of the object identifier and further improve the click conversion rate of the object. In addition, the cover is determined based on the sample media content such that the object identifier is more personalized, the creative intention of the first user may be demonstrated more intuitively, and the object-based interaction between the first user and other users is enhanced, which is conducive to improving the click conversion rate of the object.

In some embodiments, the target cover includes at least a part of the sample media content. For example, if the sample media content is a single image, the target cover may be the image, or a part of the image content of the image may be intercepted as the target cover; and if the sample media content is video, the target cover may be the video, or a video clip of the video may be intercepted as the target cover, or one or more frames of video images may be extracted from the video as the target cover.

Alternatively, if the target cover is a single image, the image may be displayed statically when the target cover is displayed; if the target image includes a plurality of images, the plurality of images may be sequentially displayed at predetermined time intervals when the target cover is displayed, and if the target image is video, the video may be played when the target cover is displayed, and during playback, audio information contained in the video may be played together, and may also be prohibited. i.e., the video may be played in a silent state.

In some embodiments, the object identifier includes a cover and an icon. Such setting has the advantage that the icon and cover compound display mode is adopted to display the object information more intuitively and comprehensively and to enhance the aesthetic degree and the attractiveness of the object identifier.

The relative display position of the icon to the cover is not limited. In some embodiments, a display region of the icon is included in a display region of the cover, and the display region of the icon covers a part of the display region of the cover. Such setting has the advantage that a display region in the associated interface can be used more effectively and the aesthetic degree of the object identifier can be improved.

In some embodiments, the target object identifier includes an original cover of the target object if no sample media content of the target object exists. In this situation, updating and displaying the target object identifier based on the target cover includes: replacing the original cover with the target cover for display when the target object identifier currently includes the original cover of the target object. Such setting has the advantage that the original cover can be set automatically when the first user does not set the sample media content, and the original cover is replaced with the target cover after the first user sets the sample media content, thus realizing personalized display of the object identifier.

The original cover may be set in a predetermined setting mode. For example, the category of the target object may be identified, and a predetermined cover corresponding to the category is determined as the original cover of the target object. It should be noted that the meaning of the category of the target object will be explained as below by taking the target object being a prop as an example. The props may be subdivided into many categories, and the category of the target object is a specific subcategory to which the prop belongs. For example, the original cover of the target object may be obtained by amplifying the icon in the target object identifier. In some embodiments, displaying, in response to the triggering for the target object identifier, the attribute setting interface of the target object corresponding to the target object identifier includes: displaying, in response to second triggering for the target object identifier, a second attribute setting interface of the target object corresponding to the target object identifier, where the second attribute setting interface includes a predetermined control, the predetermined control is configured to perform a predetermined operation on the target object, and the predetermined operation includes at least one of topping, hiding and deleting. Such setting has the advantage that the object author is provided with richer object attribute setting functions, and thus can conveniently perform attribute setting on the objects created by object author himself/herself in more dimensions.

For example, the result of the predetermined operation may be reflected by the display mode of the target object identifier. For example, when the predetermined operation is topping, the target object identifier may be displayed at the top; when the predetermined operation is hiding, the display of the target object identifier may be masked (for example, the transparency is 1, where 0 means completely opaque and 1 means completely transparent), or the display state of the target object identifier may be changed from opaque to translucent (for example, the transparency is changed from 0 to less than 1), and when the predetermined operation is deleting, the target object identifier may be deleted from the associated interface, and for the target object, it can be understood as canceling release of the target object, so that the second user cannot find the target object and the target object identifier in the associated interface of the first user.

For ease of illustration, the following explanation is made by taking a video application as an example, in which the object for creating the video may be a special-effect prop (a prop for short).

FIG. 2 is a schematic flowchart of another interface processing method according to an embodiment of the present disclosure, and the embodiment of the present disclosure is refined embodiment on the basis of various alternatives in the above embodiments. As shown in FIG. 2, the method may include the following steps.

In step 201, an associated interface of a first user is displayed in a predetermined application.

For example, the predetermined application is a video application, the associated interface is a prop display interface, the associated interface includes a prop identifier corresponding to at least one prop, the first user is an author of the at least one prop, and the prop is configured to create a video.

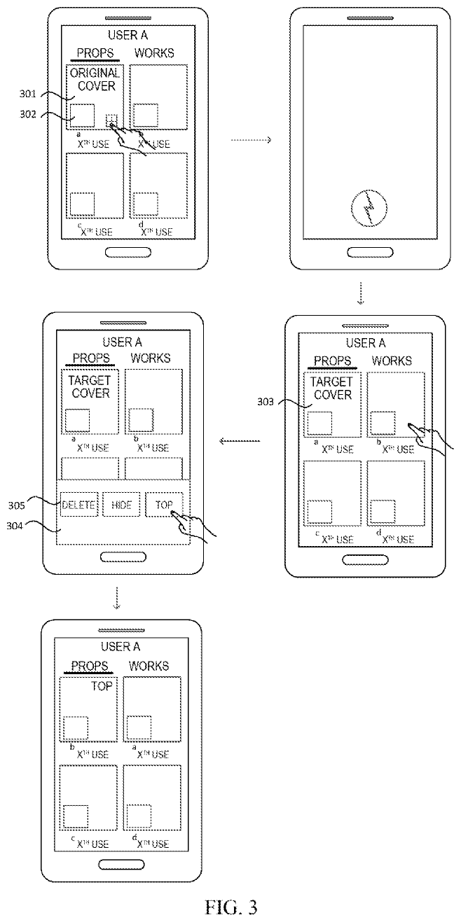

FIG. 3 is a schematic diagram of interface interaction according to an embodiment of the present disclosure. The prop display interface includes 4 prop identifiers. Taking a prop “a” as an example, a prop identifier of the prop “a” includes an original cover 301 and an icon 302, a display region of the icon 302 is included in a display region of the original cover 301, and the display region of the icon 302 covers a part of the display region of the original cover 301. The original cover 301 may be an image obtained after the icon 302 is enlarged.

In step 202, a first attribute setting interface of a first target object corresponding to a first target object identifier is displayed in response to first triggering for the first target object identifier.

The first attribute setting interface includes a capturing interface, and the capturing interface is associated with object information of the first target object.

For example, the first triggering may be clicking, and a button for triggering to display the first attribute setting interface may be displayed in the object identifier. As shown in FIG. 3, a plus button is provided in the prop identifier of the prop “a”, and the plus button is configured to set a sample media content of the prop “a”. A user A who wants to set the sample media content of the prop “a” (the first target object) may click the plus button in the prop identifier of the prop “a” to display the capturing interface corresponding to the prop “a”. The capturing interface may be loaded with prop information (not shown in the figure) in the prop “a”, for example, a sticker included in the prop “a”.

In step 203, an image is obtained based on the capturing interface, and a sample media content of the first target object is generated by using the object information of the first target object and the obtained image.

For example, the user A may capture a video by clicking a capturing button in a capturing interface, and after capturing is completed, a sample video of the prop “a” is generated according to the shot video image and the prop information of the prop “a”.

In step 204, a target cover of the target object identifier is obtained based on the sample media content, and an original cover is replaced with the target cover to update and display the first target object identifier.

For example, a video clip in the sample video may be intercepted as a target cover of the prop identifier of the prop “a”, and the original cover 301 may be replaced with a target cover 303 for display. During display of the prop identifier of the prop “a”, the target cover 303 is played when a predetermined playback condition is met, and the predetermined playback condition may be for example automatic playback or playback under the users operation.

In step 205, a second attribute setting interface of a second target object corresponding to a second target object identifier is displayed in response to second triggering for the second target object identifier, where the second attribute setting interface includes a predetermined control.

The predetermined control is configured to perform a predetermined operation on the target object, and the predetermined operation includes at least one of topping, hiding and deleting. The second triggering may be, for example, a long-press operation.

In step 206, the predetermined operation for the predetermined control is received based on the second attribute setting interface, and a display state of the second target object identifier is updated according to an attribute setting result corresponding to the predetermined operation.

As shown in FIG. 3, the user A who wants to top a prop “b” (the second target object) may lone-press a prop identifier of the prop “b” to display a second attribute setting interface 304 corresponding to the prop “b”. The second attribute setting interface 304 includes a predetermined control 305. As shown in the figure, the predetermined control may include a deleting control, a hiding control and a topping control. The user A may top the prop “b” by clicking the topping control, so that the display position of the prop identifier of the prop “b” is changed to the display position of the first prop identifier in the prop display interface.

The interface processing method provided by the embodiments of the present disclosure may be applied to a video application, and the author of a video prop may trigger the prop identifier in different ways in his/her own associated interface for displaying the prop identifier, to display different attribute setting interfaces for managing the props, and to perform various setting operations such as sample prop setting, prop deleting, prop hiding and prop topping by using different attribute setting interfaces, so that the prop author may log in to a video client by using electronic devices such as a mobile phone, and perform attribute setting on his/her own props without professional authoring tool side, which improves the convenience of prop management. The sample video shot by the prop author himself/herself is used for setting the target cover, so that the prop identifier can express the creative connotation of the prop author more accurately, which enhances the prop-based interaction between the prop author and prop users, and is conducive to improving the utilization rate and the click conversion rate of the props.

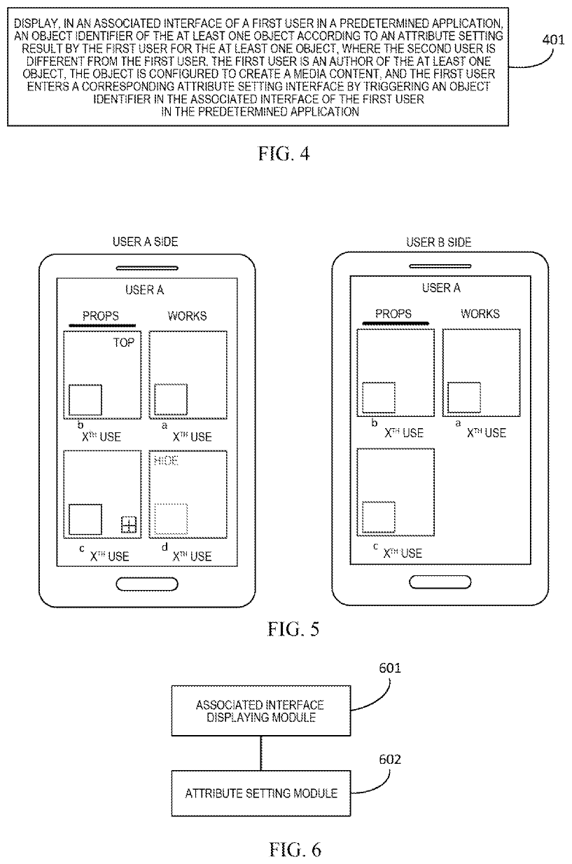

FIG. 4 is a schematic flowchart of another interface processing method according to an embodiment of the present disclosure. The method may be executed by a interface processing apparatus, and the apparatus may be implemented by software and/or hardware, and generally may be integrated into an electronic device. The electronic device may be understood as a second user side, i.e., an electronic device used by a second user. As shown in FIG. 4, the method includes the following steps.

In step 401, an object identifier of the at least one object is displayed in an associated interface of a first user in a predetermined application according to an attribute setting result by the first user for the at least one object, where the second user is different from the first user, the first user is an author of the at least one object, the object is configured to create a media content, and the first user enters a corresponding attribute setting interface by triggering an object identifier in the associated interface of the first user in the predetermined application.

In the embodiments of the present disclosure, a reference may be made to the above relevant content for related descriptions about the predetermined application, the electronic device, the first user, the associated interface, the object, the object identifier, the media content, the attribute setting interfaces and the like, which will not be repeated herein.

In the embodiments of the present disclosure, the second user may be understood as any user other than the first user, and the user may create the media content by using the object created by the first user.

In the related art, the display mode of the associated interface on the second user side is basically the same as that on the first user side. Generally, the second user may trigger the object identifier by means of clicking and the like, and then create the media content by using the corresponding object.

In the embodiments of the present disclosure, when the associated interface of the first user needs to be displayed in the predetermined application on the second user side, the object identifier of at least one object is displayed according to the attribute setting result by the first user for at least one object. The attribute setting result may include, for example, a setting result of the target cover described above and setting results of predetermined operations such as topping, hiding or deleting of the target object. Alternatively, the associated interface of the first user may be different on the first user side and the second user side. Generally, attribute description information of at least one object identifier may be displayed on the first user side, such as topping or hiding. An object identifier whose attribute is hiding is in a visible state on the first user side and is in an invisible state on the second user side.

FIG. 5 is a schematic diagram of interface comparison according to an embodiment of the present disclosure. The interface on the left side is an associated interface of a user A (the first user) on a user A side, and the interface on the right side is an associated interface of the user A on a user B (the second user) side. Compared with the interface on the user A side, the prop identifier of a prop “b” in the interface on the user B side does not contain a topping identifier. Compared with the interface on the user A side, the prop identifier of a prop “c” in a interface on the user B side does not contain a plus button. In the case where a prop “d” is set to be hidden by the user A on the user A side, a prop identifier of the prop “d” is not displayed in the interface on the user B side.

According to the interface processing method provided by the embodiments of the present disclosure, an object identifier of at least one object is displayed in an associated interface of a first user in a predetermined application according to an attribute setting result by the first user for the at least one object, where the second user is different from the first user, the first user is an author of the at least one object, the object is configured to create a media content, and the first user enters a corresponding attribute setting interface by triggering an object identifier in the associated interface of the first user in the predetermined application. By adopting the technical solution described above, the object author may synchronize, after performing attribute setting on the object created by himself/herself in the application, the attribute setting result to applications used by other users, so that the object identifier can be updated in time, and it is convenient for an object user to quickly and accurately select a satisfactory object for creating the media content.

In addition, the object identifier is displayed in a more innovative form and is more aesthetically pleasing and attractive. The object user can learn about the connotation and the use method of the object quickly and accurately by viewing the cover displayed according to the cover setting result by the object author, which enhances the object-based interaction between the object user and the object author, and is conducive to improving the click conversion rate of the object.

FIG. 6 is a structural block diagram of a interface processing apparatus according to an embodiment of the present disclosure. The apparatus may be implemented by software and/or hardware, is configured on a first user side, may be generally integrated into an electronic device, and may perform interface processing by executing the interface processing method. As shown in FIG. 6, the apparatus includes:
an associated interface displaying module 601, configured to display an associated interface of a first user in a predetermined application, where the associated interface includes an object identifier corresponding to at least one object, the first user is an author of the at least one object, and the object is configured to create a media content; and
an attribute setting module 602, configured to display, in response to triggering for a target object identifier, an attribute setting interface of a target object corresponding to the target object identifier, where the target object is one of the at least one object, and the target object identifier is an object identifier corresponding to the target object.

According to the interface processing apparatus provided in the embodiments of the present disclosure, the author of the object for creating the media content may display the attribute setting interface of the object by triggering the object identifier in the associated interface for displaying the object identifier, so that the object author can perform attribute setting on the object created by himself/herself in the application without having to do so on a professional authoring tool side, which improves the convenience of object management.

Alternatively, displaying, in response to the triggering for the target object identifier, the attribute setting interface of the target object corresponding to the target object identifier includes:
displaying, in response to first triggering for the target object identifier, a first attribute setting interface of the target object corresponding to the target object identifier, where the first attribute setting interface includes a capturing interface, and the capturing interface is associated with object information of the target object.

Alternatively, the apparatus further includes:
a sample media content generating module, configured to obtain, after displaying the capturing interface, an image based on the capturing interface, and generate a sample media content of the target object by using the object information of the target object and the image; and
an associated display module, configured to display the sample media content in association with the target object.

Alternatively, the associated display module is configured to: obtain a target cover of the target object identifier based on the sample media content; and update and display the target object identifier based on the target cover, where the target object identifier includes the target cover.

Alternatively, the target cover includes at least a part of the sample media content.

Alternatively, the object identifier includes a cover and an icon.

Alternatively, a display region of the icon is included in a display region of the cover, and the display region of the icon covers a part of the display region of the cover.

Alternatively, the target object identifier includes an original cover of the target object if no sample media content of the target object exists. In this situation, updating and displaying the target object identifier based on the target cover includes: replacing the original cover with the target cover for display when the target object identifier currently includes the original cover of the target object.

Alternatively, displaying, in response to the triggering for the target object identifier, the attribute setting interface of the target object corresponding to the target object identifier includes: displaying, in response to second triggering for the target object identifier, a second attribute setting interface of the target object corresponding to the target object identifier, where the second attribute setting interface includes a predetermined control, the predetermined control is configured to perform a predetermined operation on the target object, and the predetermined operation includes at least one of topping, hiding and deleting.

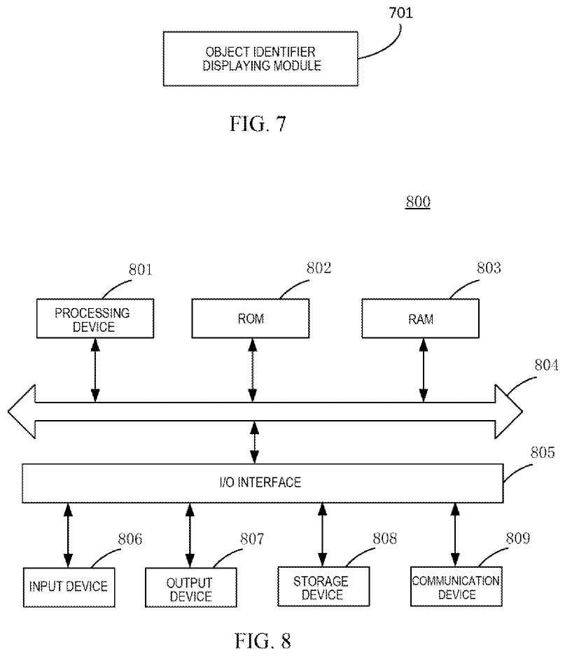

FIG. 7 is a structural block diagram of a interface processing apparatus according to an embodiment of the present disclosure. The apparatus may be implemented by software and/or hardware, is configured on a second user side, may be generally integrated into an electronic device, and may perform interface processing by executing the interface processing method. As shown in FIG. 7, the apparatus includes:
an object identifier displaying module 701, configured to display, in an associated interface of a first user in a predetermined application, an object identifier of at least one object according to an attribute setting result by the first user for the at least one object, where the second user is different from the first user, the first user is an author of the at least one object, the object is configured to create a media content, and the first user enters a corresponding attribute setting interface by triggering an object identifier in the associated interface of the first user in the predetermined application.

According to the interface processing apparatus provided in the embodiments of the present disclosure, the object author may synchronize, after performing attribute setting on the object created by himself/herself in the application, an attribute setting result to applications used by other users, so that the object identifier can be updated in time, and it is convenient for an object user to quickly and accurately select a satisfactory object for creating the media content.

A reference is now made to FIG. 8, which is a schematic structural diagram of an electronic device 800 suitable for implementing the embodiments of the present disclosure. The electronic device in the embodiments of the present disclosure may include, but is not limited to, mobile terminals such as a mobile phone, a notebook computer, a digital broadcast receiver, a personal digital assistant (PDA), a PAD (tablet computer), a portable media player (PMP) and a vehicle-mounted terminal (for example, a vehicle-mounted navigation terminal), and fixed terminals such as a digital television (TV) and a desktop computer. The electronic device shown in FIG. 8 is merely an example, and should not impose any limitation to the function or the scope of application of the embodiments of the present disclosure.

As shown in FIG. 8, the electronic device 800 may include a processing device (such as a central processing unit and a graphics processor) 801, which may execute various appropriate actions and processing according to a program stored in a read-only memory (ROM) 802 or a program loaded to a random access memory (RAM) 803 from a storage device 808. Various programs and data required during operation of the electronic device 800 are also stored in the RAM 803. The processing device 801, the ROM 802 and the RAM 803 are connected with one another via a bus 804. An input/output (I/O) interface 805 is also connected to the bus 804.

Generally, the following apparatuses may be connected to the I/O interface 805: an input device 806 including for example a touch screen, a touch pad, a keyboard, a mouse, a camera, a microphone, an accelerometer and a gyroscope; an output device 807 including for example a liquid crystal display (LCD), a speaker and a vibrator; a storage device 808 including for example a magnetic tape and a hard disk, and a communication device 809. The communication device 809 may allow wireless or wired communication between the electronic device 800 and other devices for data exchange. Although FIG. 8 shows the electronic device 800 having various devices, it should be understood that not all the devices shown are necessarily required to be implemented or provided. More or fewer devices may alternatively be implemented or provided.

In particular, according to the embodiments of the present disclosure, the process described above with reference to the flowcharts may be implemented as a computer software program. For example, an embodiment of the present disclosure provides a computer program product including a computer program carried on a non-transient computer-readable medium. The computer program includes a program code for executing the methods shown in the flowcharts. In such an embodiment, the computer program may be downloaded and installed from the network via the communication device 809, or installed from the storage device 808, or installed from the ROM 802. The computer program, when executed by the processing unit 801, causes the processing unit to execute the above functions defined in the methods according to the embodiments of the present disclosure.

It should be noted that the computer-readable medium according to the present disclosure may be a computer-readable signal medium or a computer-readable storage medium or any combination of the two. The computer-readable storage medium may be, for example, but is not limited to, an electrical, magnetic, optical, electromagnetic, infrared, or semiconductor system, apparatus, or device, or any combination thereof. More specific examples of the computer-readable storage medium include but are not limited to: an electrical connection with at least one wire, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program. The program may be used by or used in combination with an instruction execution system, apparatus, or device. However, in the present disclosure, the computer-readable signal medium may include a data signal propagated in baseband or as a part of a carrier wave, and computer-readable program code is carried therein. This propagated data signal may take many forms, including but not limited to electromagnetic signals, optical signals, or any suitable combination thereof. The computer-readable signal medium may also be any computer-readable medium other than the computer-readable storage medium. The computer-readable signal medium may send, propagate, or transmit the program used by or used in combination with the instruction execution system, apparatus, or device. The program code contained on the computer-readable medium may be transmitted by any suitable medium, including but not limited to, wire, optical cable, RF, etc., or any suitable combination thereof.

The computer-readable medium may be included in the electronic device described above, or it may stand alone without being assembled into the electronic device.

The computer-readable medium carries at least one program, and the at least one program described above, when executed by the electronic device, causes the electronic device to:
display an associated interface of a first user in a predetermined application, where the associated interface includes an object identifier corresponding to at least one object, the first user is an author of the at least one object, and the object is configured to create a media content; and display, in response to triggering for a target object identifier, an attribute setting interface of a target object corresponding to the target object identifier, where the target object is one of the at least one object, and the target object identifier is an object identifier corresponding to the target object;
or, display, in an associated interface of a first user in a predetermined application, an object identifier of at least one object according to an attribute setting result by the first user for the at least one object, where the second user is different from the first user, the first user is an author of the at least one object, the object is configured to create a media content, and the first user enters a corresponding attribute setting interface by triggering an object identifier in the associated interface of the first user in the predetermined application.

The computer program code for performing the operations of the present disclosure may be written in one or more programming languages or a combination thereof, which include but are not limited to object-oriented programming languages Java, Smalltalk, C++, and conventional procedural programming languages such as “C” or similar programming languages. The program codes may be executed completely on a user computer, partially on a user computer, as an independent package, partially on a user computer and partially on a remote computer, or completely on a remote computer or server. In cases involving a remote computer, the remote computer may be connected to a user computer through any type of network, including a local area network (LAN) or a wide area network (WAN), or may be connected to an external computer (for example, through the Internet by using an Internet service provider).

The flowcharts and the block diagrams in the drawings illustrate system architectures, functions and operations that may be implemented based on the system, method and computer program product according to various embodiments of the present disclosure. In this regard, each block in the flowcharts or the block diagrams can represent one module, a program segment or a part of a code, and the module, the program segment or the part of the code includes at least one executable instruction for implementing specific logic functions. It should also be noted that, in some alternative implementations, the functions noted in the blocks may also occur in a sequence different from those illustrated in the drawings. For example, two consecutive blocks may be executed substantially in parallel, and may sometimes be executed in an opposite order, depending on the functions involved. It should also be noted that each block in the block diagrams and/or the flowcharts, and combinations of the blocks in the block diagrams and/or the flowcharts can be implemented in a dedicated hardware-based system that performs the specified functions or operations, or can be implemented by the combination of dedicated hardware and computer instructions.

The modules described in the embodiments of the present disclosure may be implemented by way of software or hardware. In some cases, the names of the modules do not constitute limitations to the modules themselves. For example, the associated interface displaying module may also be described as “a module that displays an associated interface of a first user in a predetermined application, where the associated interface includes an object identifier corresponding to at least one object, the first user is an author of the at least one object, and the object is configured to create a media content”.

The functions described above herein may be at least partially performed by one or more hardware logic components. For example, non-restrictively, example types of hardware logic components that may be used include: a field programmable gate array (FPGA), an application-specific integrated circuit (ASIC), an application-specific standard parts (ASSP), a system-on-chip (SOC), a complex programmable logic device (CPLD), and the like.

In the context of the present disclosure, the machine-readable medium may be a tangible medium that may contain or store a program used by or used in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination thereof.

According to at least one embodiment of the present disclosure, a interface processing method is provided, on a first user side, including:
displaying an associated interface of a first user in a predetermined application, where the associated interface includes an object identifier corresponding to at least one object, the first user is an author of the at least one object, and the object is configured to create a media content; and
displaying, in response to triggering for a target object identifier, an attribute setting interface of a target object corresponding to the target object identifier, where the target object is one of the at least one object, and the target object identifier is an object identifier corresponding to the target object.

Alternatively, displaying, in response to the triggering for the target object identifier, the attribute setting interface of the target object corresponding to the target object identifier includes:
displaying, in response to first triggering for the target object identifier, a first attribute setting interface of a target object corresponding to the target object identifier, where the first attribute setting interface includes a capturing interface, and the capturing interface is associated with object information of the target object.

Alternatively, after displaying the capturing interface, the method further includes:
obtaining an image based on the capturing interface, and generating a sample media content of the target object by using the object information of the target object and the image; and
displaying the sample media content in association with the target object.

Alternatively, displaying the sample media content in association with the target object includes:
obtaining a target cover of the target object identifier based on the sample media content; and
updating and displaying the target object identifier based on the target cover, where the target object identifier includes the target cover.

Alternatively, the target cover includes at least a part of the sample media content.

Alternatively, the object identifier includes a cover and an icon.

Alternatively, a display region of the icon is included in a display region of the cover, and the display region of the icon covers a part of the display region of the cover.

Alternatively, the target object identifier includes an original cover of the target object if no sample media content of the target object exists, and
updating and displaying the target object identifier based on the target cover includes;
replacing the original cover with the target cover for display when the target object identifier currently includes the original cover of the target object.

Alternatively, displaying, in response to the triggering for the target object identifier, the attribute setting interface of the target object corresponding to the target object identifier includes:
displaying, in response to second triggering for the target object identifier, a second attribute setting interface of the target object corresponding to the target object identifier, where the second attribute setting interface includes a predetermined control, the predetermined control is configured to perform a predetermined operation on the target object, and the predetermined operation includes at least one of topping, hiding and deleting.

According to at least one embodiment of the present disclosure, a interface processing method is provided, on a second user side, including:
displaying, in an associated interface of a first user in a predetermined application, an object identifier of at least one object according to an attribute setting result by the first user for the at least one object, where the second user is different from the first user, the first user is an author of the at least one object, the object is configured to create a media content, and the first user enters a corresponding attribute setting interface by triggering an object identifier in the associated interface of the first user in the predetermined application.

According to at least one embodiment of the present disclosure, a interface processing apparatus is provided, configured on a first user side and including:
an associated interface displaying module, configured to display an associated interface of a first user in a predetermined application, where the associated interface includes an object identifier corresponding to at least one object, the first user is an author of the at least one object, and the object is configured to create a media content; and
an attribute setting module, configured to display, in response to triggering for a target object identifier, an attribute setting interface of a target object corresponding to the target object identifier, where the target object is one of the at least one object, and the target object identifier is an object identifier corresponding to the target object.

According to at least one embodiment of the present disclosure, a interface processing apparatus is provided, configured on a second user side and including:
an object identifier displaying module, configured to display, in an associated interface of a first user in a predetermined application, an object identifier of at least one object according to an attribute setting result by the first user for the at least one object, where the second user is different from the first user, the first user is an author of the at least one object, the object is configured to create a media content, and the first user enters a corresponding attribute setting interface by triggering an object identifier in the associated interface of the first user in the predetermined application.

According to at least one embodiment of the present disclosure, an electronic device is provided, including a memory, a processor and a computer program stored on the memory and runnable on the processor, where the processor, when executing the computer program, implements the interface processing method according to any embodiment of the present disclosure.

According to at least one embodiment of the present disclosure, a computer-readable storage medium is provided, where a computer program is stored on the computer-readable storage medium, and the computer program, when executed by a processor, implements the interface processing method according to any embodiment of the present disclosure.

In addition, although various operations are depicted in a specific order, it should not be understood as requiring such operations to be performed in the specific order shown or in a sequential order. Under given conditions, multi-task processing and parallel processing may be advantageous. Similarly, although details of several specific implementations are included in the foregoing discussion, these details should not be construed as a limitation to the scope of the present disclosure. Some features described in the context of individual embodiments may also be implemented in a single embodiment in combination. On the contrary, various features described in the context of a single embodiment may also be implemented in a plurality of embodiments separately or in any suitable sub-combination.

What is claimed is:

1. A method of interface processing, on a side of a first user, comprising:
displaying an associated interface of the first user, wherein the associated interface includes an object identifier corresponding to at least one object, the first user is an author of the at least one object, and the at least one object is configured to create a media content; and
in response to triggering for a target object identifier, displaying an attribute setting interface of a target object corresponding to the target object identifier, wherein the target object is one of the at least one object, and the target object identifier is an object identifier corresponding to the target object.

2. The method according to claim 1, wherein in response to the triggering for the target object identifier, displaying the attribute setting interface of the target object corresponding to the target object identifier comprises:
in response to first triggering for the target object identifier, displaying a first attribute setting interface of the target object corresponding to the target object identifier, wherein the first attribute setting interface includes a capturing interface, and the capturing interface is associated with object information of the target object.

3. The method according to claim 2, after displaying the capturing interface, further comprising:
obtaining an image based on the capturing interface, and generating a sample media content of the target object by using the object information of the target object and the image; and
displaying the sample media content in association with the target object.

4. The method according to claim 3, wherein displaying the sample media content in association with the target object comprises:
obtaining a target cover of the target object identifier based on the sample media content; and
updating and displaying the target object identifier based on the target cover, wherein the target object identifier comprises the target cover.

5. The method according to claim 4, wherein the target cover includes at least a part of the sample media content.

6. The method according to claim 5, wherein the object identifier comprises a cover and an icon.

7. The method according to claim 6, wherein a display region of the icon is included in a display region of the cover, and the display region of the icon covers a part of the display region of the cover.

8. The method according to claim 6, wherein the target object identifier comprises an original cover of the target object if no sample media content of the target object exists; and
updating and displaying the target object identifier based on the target cover comprises:
replacing the original cover with the target cover for display with the target object identifier currently comprising the original cover of the target object.

9. The method according to claim 1, wherein in response to the triggering for the target object identifier, displaying the attribute setting interface of the target object corresponding to the target object identifier comprises:
in response to second triggering for the target object identifier, displaying a second attribute setting interface of the target object corresponding to the target object identifier, wherein the second attribute setting interface comprises a predetermined control, the predetermined control is configured to perform a predetermined operation on the target object, and the predetermined operation comprises at least one of topping, hiding and deleting.

10-15. (canceled)

16. An electronic device, comprising a memory, a processor and a computer program stored on the memory and runnable on the processor, the processor, upon executing the computer program, performing:
displaying an associated interface of the first user in a predetermined application, wherein the associated interface includes an object identifier corresponding to at least one object, the first user is an author of the at least one object, and the at least one object is configured to create a media content; and
in response to triggering for a target object identifier, displaying an attribute setting interface of a target object corresponding to the target object identifier, wherein the target object is one of the at least one object, and the target object identifier is an object identifier corresponding to the target object.

17. The electronic device according to claim 16, wherein the processor, upon executing the computer program, further performs:
in response to first triggering for the target object identifier, displaying a first attribute setting interface of the target object corresponding to the target object identifier, wherein the first attribute setting interface includes a capturing interface, and the capturing interface is associated with object information of the target object.

18. The electronic device according to claim 17, wherein the processor, upon executing the computer program, further performs, after displaying the capturing interface:
obtaining an image based on the capturing interface, and generating a sample media content of the target object by using the object information of the target object and the image; and
displaying the sample media content in association with the target object.

19. The electronic device according to claim 18, wherein the processor, upon executing the computer program, further performs:
obtaining a target cover of the target object identifier based on the sample media content; and
updating and displaying the target object identifier based on the target cover, wherein the target object identifier comprises the target cover.

20. The electronic device according to claim 19, wherein the target cover includes at least a part of the sample media content.

21. The electronic device according to claim 20, wherein the object identifier comprises a cover and an icon.

22. The electronic device according to claim 21, wherein a display region of the icon is included in a display region of the cover, and the display region of the icon covers a part of the display region of the cover.

23. The electronic device according to claim 21, wherein the target object identifier comprises an original cover of the target object if no sample media content of the target object exists; and
wherein the processor, upon executing the computer program, further performs:
replacing the original cover with the target cover for display with the target object identifier currently comprising the original cover of the target object.

24. The electronic device according to claim 16, wherein the processor, upon executing the computer program, further performs:
in response to second triggering for the target object identifier, displaying a second attribute setting interface of the target object corresponding to the target object identifier, wherein the second attribute setting interface comprises a predetermined control, the predetermined control is to perform a predetermined operation on the target object, and the predetermined operation comprises at least one of topping, hiding and deleting.

25. A non-transitory computer-readable storage medium having a computer program stored thereon, the computer program, upon executed by a processor, performing:
displaying an associated interface of the first user in a predetermined application, wherein the associated interface includes an object identifier corresponding to at least one object, the first user is an author of the at least one object, and the at least one object is configured to create a media content; and
in response to triggering for a target object identifier, displaying an attribute setting interface of a target object corresponding to the target object identifier, wherein the target object is one of the at least one object, and the target object identifier is an object identifier corresponding to the target object.

26. The computer-readable storage medium according to claim 25, wherein the computer program, upon executed by a processor, further performs:
in response to first triggering for the target object identifier, displaying a first attribute setting interface of the target object corresponding to the target object identifier, wherein the first attribute setting interface includes a capturing interface, and the capturing interface is associated with object information of the target object.
